(19) United States
(12) Patent Application Publication
(10) Pub. No.: US 2024/0142931 A1
(43) Pub. Date: May 2, 2024

(54) DOOR SYSTEM FOR ONE OR A PLURALITY OF DOORS WITH A PLURALITY OF DOOR COMPONENTS AS WELL AS A FIRST COMMUNICATION BUS

(71) Applicants: DORMAKABA DEUTSCHLAND GMBH, Ennepetal (DE); DORMAKABA SCHWEIZ AG, Rümlang (CH); DORMAKABA EAD GMBH, Villingen-Schwennigen (DE)

(72) Inventors: Stephan GIERNICH, Bonn (DE); Dennis MEIERING, Ennepetal (DE); Thomas VOGLER, Ennepetal (DE); Sven BUSCH, Ennepetal (DE); Ingo HALDER, Ennepetal (DE); Bernd GEHRMANN, Ennepetal (DE); Andrzej DUDZINSKI, Ennepetal (DE); Chandra Prakash GUPTA, Ennepetal (DE); Oliver BORCHMANN, Ennepetal (DE); Frank LORENZ, Rümlang (CH)

(21) Appl. No.: 18/547,457

(22) PCT Filed: Feb. 23, 2022
(86) PCT No.: PCT/EP2022/054530

§ 371 Date: Aug. 22, 2023

(30) Foreign Application Priority Data
Feb. 24, 2021 (EP) 21159071.6
Aug. 19, 2021 (WO) PCT/EP2021/073068

(51) Int. Cl. G05B 19/042; G07C 9/00

(52) U.S. Cl. CPC G05B 19/0425; G07C 9/00309; G07C 9/00944; G05B 2219/40062

(57) ABSTRACT

A door system for at least one door, the door system including door components, with one of the components being designed as a control unit. The control unit and at least one other door component are connected to one another via a first communication bus.

An access system with an above door system and with a computing unit are related, with an image of the door system stored in the computing unit, the door components connected to the first communication bus each having an identifier. The identifiers are stored as part of the image of the door system in the computing unit and/or with past and current operating states of the door system stored in the computing unit.

An access system with at least one of the above door systems is related, with at least one door system having an authentication device configured to receive an access attribute for authentication.

### CROSS-REFERENCE TO RELATED APPLICATIONS

This application is a 35 U.S.C. § 371 National Stage patent application of PCT/EP2022/054530, filed on 23 Feb. 2022, which claims the benefit of International Application No. PCT/EP2021/073068, filed on 19 Aug. 2021, which claims the benefit of European patent application 21159071.6, filed on 24 Feb. 2021, the disclosures of which are incorporated herein by reference in their entirety.

### TECHNICAL FIELD

The present disclosure relates to a door system for one or a plurality of doors, with the door system comprising a plurality of door components as defined in more detail in claim 1.

### BACKGROUND

Various door systems with different components are known from the prior art in order to reliably cover different types of applications. For example, it is known to design door systems both with an escape route security system and with a motorized door drive or an access control system. Correspondingly, motor-driven doors can be provided as escape doors, with additional functions sometimes being required, for example for fire protection.

The motorized door drive comprises a drive motor and a drive controller in order to open and/or close an associated door. For this purpose, the motorized door drive can additionally comprise one or a plurality of sensors in order to monitor one or both sides of the door and to control the drive motor in order to open the door when a person approaches. The same applies to closing the door when the person moves away again.

The escape route security system serves in particular to provide escape routes. Escape route doors must always be able to be opened, for example to ensure that a building can be exited in the event of an evacuation. At the same time, to prevent unauthorized intrusion, the escape doors typically comprise an electrically actuated door lock as access protection, which must be unlocked to ensure exit from the building. As fire protection doors, escape route doors can close automatically in the event of a fire, for example, with the function as an escape door having to be ensured, i.e. the escape door must be able to be opened even in the event of a fire.

Authentication devices or access control systems with a plurality of authentication devices or detection units are used to allow only authorized persons access to a spatial region.

In practice, door systems with a plurality of door components are often installed by different trades. This can, for example, relate to a door system with one or a plurality of door drives, access control devices or systems and/or an escape route security system. This can result in adjustment errors. More and more different installations of door systems are being carried out, for which efficient and smooth installation, reliable operation or, for example, secure protection against unauthorized entry must be guaranteed.

### SUMMARY

The present disclosure at least partially overcomes at least one disadvantage described above. In particular, the present disclosure provides a door system of the type described above, which in particular ensures efficient and smooth installation and/or reliable operation of all door components. In particular, a gain in efficiency and safety during installation and/or operation should be achieved in a door system with a drive controller, an escape route security system and/or an access control system. the disclosure also provides an access system with such a door system, in which a gain in efficiency and safety can be achieved during installation and/or operation.

The above is achieved by providing a door system with the features of claim 1. Further features and details of the disclosure result from the respective dependent claims, the description and the drawings.

The advantages are achieved in particular by providing a door system for one or a plurality of doors. The door system comprises a plurality of door components, with one of the door components being designed as a control unit. The control unit and at least one other door component are connected to one another via a first communication bus.

The door system according to the disclosure is characterized in that a control unit is provided which is connected to at least one other door component, preferably a plurality of other door components, via the communication bus and communication can thus take place between the control unit and the other door components. The door system according to the disclosure thus provides a possibility of communication between the control unit and the at least one other door component via the first communication bus, which can be implemented easily. As a result, the control unit can, for example, take on central control tasks and thus control the other door components in an efficient manner, at least by way of a higher-level controller. The other door components can also perform additional control tasks. For example, a drive controller can actuate an electric drive motor to open, close and/or hold a door. Analog signaling or also separate communication can thereby take place between this door component and other door components in order to carry out the control tasks. It is also possible for the communication between this door component and other door components to take place via the first communication bus.

In addition, the other door components can also communicate with one another, to the extent that this is necessary, either directly or via the control unit. For example, alarms, for example from a hazard sensor, can be transmitted directly to all other door components.

It is also possible that each of the door components of the door system not only sends a message to another door component, but also sends messages as a broadcast to all other door components or as a multicast to a plurality of other door components.

For communication purposes, messages can be exchanged between the door components via the first communication bus, for example in order to control the operation of the door system directly or via an adjusted configuration. Different types of messages can thus be exchanged via the first communication bus, for example in order to configure the door components or to synchronize different actions of the door components with one another. The messages can thereby contain information that is sent from the door components to other door components. For example, a door component can provide information about its own actions or communicate its own configuration. The same applies to instructions or commands from door components to other door components. An exchange of corresponding messages enables the control to be carried out flexibly, since such messages can be easily adapted.

The sending of the messages can easily be adapted via the first communication bus. This means that door systems in which the door components communicate with one another via the first communication bus can be easily installed, expanded or changed. An information technology connection of the door components only requires the connection to the communication bus. This makes installation, maintenance and operation of the door system easier than simple signal lines between individual door components, via which individual information is transmitted as an analog or digital voltage level.

The control unit is preferably a data processing device. Accordingly, the control unit preferably comprises a processor and a memory in which a program for execution in the control unit is stored. The control unit may have an operating system, for example based on Linux or others, with the program being executed using the operating system. Alternatively, the program can be executed directly by the control unit without an operating system. It can be provided that the control unit carries out a coordinated process of the control of the door system. In this case, the control unit has a corresponding program.

The control unit can comprise a timer for determining the time and/or a period of time.

The door system can, for example, comprise door components for implementing a motorized door drive, an access system or an escape route security system. The other door components can thus themselves be control components, for example a drive controller of the motorized door drive, an escape route controller of the escape route security system or a controller of an electromechanical lock, lock cylinder or fitting. Alternatively or additionally, the other door components can comprise actuators and/or sensors as well as a reading unit for recording authorizations.

A high degree of freedom for the door system can be achieved by way of the first communication bus, in that the door components can communicate with one another simply and reliably. As a result, complex control processes in particular can also be easily implemented with the door system. This applies in particular if the door system comprises, for example, a plurality of actuators and/or sensors as door components which together contribute to the control of functions of the door system.

In principle, the first communication bus can comprise any connection between the door components for the transmission of digital messages containing data. In principle, any protocols can be used for the first communication bus, which can be implemented both by software and by hardware. The first communication bus can be designed for unidirectional communication, in which only one of the door components sends messages, or for example for bidirectional communication, in which two door components can send messages at the same time.

The first communication bus can be wired or wireless. A wired first communication bus can be implemented, for example, via electrical cables or also via optical cables. In principle, the first communication bus can also have any topology. The first communication bus may be designed to be parallel, star-shaped, in-line, daisy-chained, or a combination thereof. The topology does not have to reflect any logical dependency between individual door components. Various wireless transmission standards can be used in a wireless first communication bus, for example Bluetooth, in particular Bluetooth Low Energy (BLE), W-LAN, DECT or others.

In principle, the first communication bus can use any transmission protocol. Frequently used transmission protocols are, for example, CAN, Flexray, LIN, DCW, Ethernet, LON or LAN. The first communication bus can be implemented, for example, as a field bus or also based on an IP-enabled transmission protocol that is customary in the IT sector. The use of the first communication bus has the advantage that door components which are standardized with regard to communication can be used easily and can be provided easily and flexibly. This simplifies the installation of the door system as a whole. For example, a CAN bus is used.

It can thereby be ensured in different ways that all door components can use the first communication bus as required. For example, bitwise arbitration can be carried out, with each door component having a prioritization/identification, and when sending at the same time, the door component which has the highest prioritization is allowed to continue sending its message. Such methods are known, for example, under the term CSMA/CR, in order to immediately resolve possible collisions when accessing the first communication bus. Alternatively, equal access to the first communication bus is also possible, for example in the manner of collision detection (CSMA/CD). As a further alternative, a door component, in particular the control unit, can act as a master, which assigns the resources of the first communication bus to the other door components as so-called slaves, with the resources being at least partially fixedly assigned to the slaves, for example in the form of time slots (TDMA).

The first communication bus can thereby comprise a combination of different topologies, transmission protocols and/or access methods with or without cables.

According to an advantageous further development of the disclosure, it can be provided that the control unit can be connected to a second, in particular IP-enabled, communication bus, with the control unit being designed to communicate with a computing unit via the second communication bus.

It is preferably provided that the control unit receives an electronic configuration of the door system via the second communication bus. The electronic configuration can be designed as an initial configuration for commissioning the door system or as an update of the initial configuration.

The electronic configuration preferably comprises at least one, preferably a plurality of, particularly preferably all of the following electronic data:
door component types of the door system,
transmitters and/or receivers of messages in the door system (in particular via the first communication bus),
parameters for operating the door system,
a test process for the door system, in which at least one function or a functional process of the door system is tested for commissioning,
at least one access attribute, based on which the control unit makes an access decision.

The configuration of the door system can therefore be sent by the computing unit and/or received by the control unit. In one embodiment variant, it is not necessary for the door system to be configured directly during installation on site. This allows the tasks of installation/mounting and configuration to be separated. This shortens a period of time for installing the door system on site. Also, specialists can perform the respective tasks in an efficient manner. It is not necessary for every installer/assembler to have in-depth knowledge of configuring door systems and vice versa.

The electronic configuration of the door system can be carried out as a remote configuration via the second communication bus, with a user interface of the control unit being provided via the computing unit by means of software, for example as a graphical user interface (GUI). Further door components connected to the control unit via the first communication bus are preferably detected during the electronic configuration.

A comparison can be made as to whether the other door components correspond to a desired function of the door system. For this purpose, the installed door components can preferably be compared with door component types provided in the door system to be installed, in particular by the control unit and/or a mobile terminal. A door component type is defined in particular by the function that the door component type has in relation to the door on which the door component is installed. Door component types can additionally or alternatively differ by properties of the door on which the door component is installed or by functional properties of the door component type itself. For example, the other door components that are connected to the first communication bus report to the control unit which door component type the door components belong to. The control unit can then carry out the comparison.

In addition, a functional test of the other door components can be carried out before the configuration. The same applies to a test of the communication of the door components via the first communication bus. In the course of the electronic configuration, a current configuration of the door system with its door components can be recorded, i.e. the configuration is transmitted from the control unit to the computing unit, for example.

Furthermore, at least one function or a functional process of the door system can be tested and thus ensured in a test process for commissioning. Such tests can be evaluated via sensors of the door system and/or by a person on site.

Authorizations relate, for example, to an access authorization, an authorization to deactivate alarms, an authorization to set operating modes or others.

The door system can be designed to receive an access attribute of an authorized user. The access attribute can be used to determine authorization for access from the door system. The door system can comprise a detection unit for receiving an access attribute. The detection unit can be designed as a transmitting and receiving unit, as a biometric sensor, as a keypad for inputting a PIN and/or as a contact element for making electrical contact with an in particular electronic key. The access attribute can be designed as a credential or a biometric feature of the user. The access attribute, in particular the credential, can comprise an access code and/or at least one time window in which access is authorized.

In particular, access attributes can also comprise information about the full or partial opening of a door or the like.

The data of the electronic configuration is transmitted with messages between the control unit and the computing unit. Data or a current configuration of the control unit are transmitted therefrom to the computing unit. A changed configuration is transmitted from the computing unit to the control unit. In particular, the electronic configuration or a change in the electronic configuration is set on a mobile terminal and transmitted directly or indirectly to the control unit. In addition, the control unit can transmit individual parameters to the other door components via the first communication bus, so that they can be used in the corresponding door components.

The second communication bus preferably provides a connection to the Internet or the cloud, so that the control unit can be connected to a corresponding computing unit in the cloud. The connection is preferably secured, and the second communication bus can be connected to the Internet, for example via a secure communication unit, for example a firewall, in order to protect the door system against unauthorized access via the Internet. Alternatively, the second communication bus can be designed as an internal network (intranet), for example of a building with the door system, with the internal network in turn being able to be connected to the Internet. The computing unit can be part of the intranet.

According to an advantageous further development of the disclosure, it can be provided that the control unit comprises a transmitting and/or receiving unit for wireless near-field communication, in particular Bluetooth Low Energy.

It can be provided that the transmitting and/or receiving unit can be used to communicate with a terminal, in particular the mobile terminal, for commissioning, for configuring and/or for access authorization communication. A user interface can thus be provided via the terminal, as described above for the computing unit, in order to carry out the commissioning, configuration and/or access authorization communication. The mobile terminal can thus be a portable data processing unit, for example a laptop, mobile telephone or tablet computer. The wireless communication connection can use any wireless transmission standard, for example Bluetooth, in particular Bluetooth Low Energy (BLE), W-LAN, DECT or others. The transmitting and/or receiving unit can be connected to the control unit via the first communication bus or directly. A reading unit can comprise the transmitting and/or receiving unit in order, for example, to record access attributes of people during operation and/or to carry out authentication with the control unit.

Alternatively or additionally, the control unit can comprise a wired transmission unit for communication with a terminal, in particular a mobile terminal or a mobile memory unit, for commissioning, for configuring and/or for access authorization communication. A wired communication connection can be implemented, for example, via electrical cables, in particular USB or other interfaces, or also via optical cables. The statements made above with regard to the wireless transmitting and/or receiving unit apply accordingly. The mobile memory unit can be designed e.g. as a USB stick.

According to an advantageous further development of the disclosure, it can be provided that the control unit is designed to make an access decision.

It is preferably provided that the door system comprises at least one electrical locking device, with the unlocking time for which the locking device is to be unlocked in the event of a positive access decision being stored in the control unit and/or being receivable by the control unit.

The access decision is preferably made based on an access attribute received by the detection unit from the door system, in particular from an authentication device. The control unit preferably serves as an authentication device. In particular, a credential received from a reading unit can be evaluated by the authentication device. For example, the received access code can be compared with an access code stored in the authentication device, in particular in the control unit. Additionally or alternatively, a time window of the credential can be compared with the current time.

The reading unit can be designed to record biometric data of an access person, in particular as a reading unit for a fingerprint or for iris recognition, as an electronic keypad for inputting an access code, or in other ways. The reading unit can comprise the detection unit.

If the door system comprises a key switch, for example, the access decision can also be made based on a corresponding actuation with a key.

The locking device can bring about an electrical unlocking of the door. The locking device can be designed, for example, as an electrically actuatable door lock of an escape route security system, as a motor lock, in particular a plug-in motor lock, or as a motorized lock cylinder. The locking device can allow manual unlocking. For example, the locking device can be designed as a door opener, as an electromechanical lock cylinder or as an electromechanical fitting.

The at least one locking device can be connected to the control unit via the first communication bus. Preferably, a plurality of locking devices are connected to the first communication bus.

The unlocking time is a time during which the locking device unlocks the door or prevents mechanical locking, and can be centrally defined and possibly also monitored by the control unit.

According to an advantageous further development of the disclosure, it can be provided that the unlocking time and/or a monitoring time before the door system outputs an alarm when the door is open, is stored in the control unit and/or can be received by the control unit individually for different authorized users or for different authorized user groups or for different access attributes/or access attribute groups. An adjusted and individual setting of the unlocking time and/or the monitoring time can thus take place, with the times being able to be set differently for different doors of the door system.

The unlocking time and/or the monitoring time is/are preferably set centrally and, if necessary, also monitored by the control unit. Alternatively, the unlocking time and/or the monitoring time can be set and/or monitored in an escape route controller, for example. A staggered alarm is preferably generated, for example with a pre-alarm and a main alarm that triggers afterwards. In order to trigger an alarm at the end of the monitoring time, the door system preferably comprises a door status sensor. The door status sensor serves to detect whether a door is open or closed.

Unlocking time and/or monitoring time is/are preferably set individually for each authorized user, each authorized user group, each access attribute, each access attribute group, for example as a configuration in the control unit or via the control unit. In this way, different users or different user groups can be taken into account. The unlocking time and/or the monitoring time can thus be configured differently for a first authorized user than for a second authorized user. For example, the unlocking time and/or the monitoring time is set to be longer for a wheelchair user than for a walking user. In another example, the unlocking time and/or the monitoring time can be set to be longer for an old person than for a young person. The authorized users can thereby be divided into different user groups.

The control unit preferably comprises a database. The unlocking time and/or the monitoring time can be assigned in each case to different users or different user groups in the database. The control unit can recognize the user by the access attribute.

Additionally or alternatively, the unlocking time and/or the monitoring time can be receivable by the door system, in particular by the control unit, in particular as part of an access attribute. It is therefore not necessary to store the unlocking time and/or the monitoring time in a database of the control unit. Rather, the control unit always receives the unlocking time and/or the monitoring time when the authorized user requests access. In particular, the access attribute comprises the unlocking time and/or the monitoring time. The access attribute is received via the detection unit, in particular via the transmitting and receiving unit. This means that the parameter is currently recorded again by the door system with each access. For example, the access attribute is recorded by the reading unit.

Additionally or alternatively, at least the unlocking time and/or the monitoring time can be stored individually for access attributes or for access attribute groups in the door system, in particular in the control unit. The control unit preferably comprises a database in which the unlocking time and/or the monitoring time is assigned to different access attributes or different access attribute groups. For example, a nurse may carry multiple cards depending on whether the nurse is seeking access alone or with a hospital bed. This means that a plurality of access attributes can be assigned to the same user. A user can, for example, be assigned different access means, such as a mobile terminal with one or a plurality of stored access attributes, an authorization card, or an authorization chip, with different unlocking times and/or monitoring times being assigned to the access means or the access attributes.

Additionally or alternatively, the unlocking time and/or the monitoring time can depend on the use of the access attribute. The control unit preferably comprises a database in which the unlocking time and/or the monitoring time is linked to the use of the access attribute. The use can comprise e.g. a gesture in relation to the detection unit. For example, a card can be held in front of the reading unit for a long or short time. For example, the unlocking time for a long hold of the card is stored in the database with a longer period of time than for a short hold. It can thus be provided that the unlocking time and/or the monitoring time is set for the same user depending on a type of use of the access attribute.

The door system, in particular the control unit, can be designed to actuate or initiate actuation of a locking device for unlocking a door leaf or a plurality of locking devices for unlocking a plurality of door leaves based on the access attribute and/or the type of use of the access attribute. Thus, based on the access attribute, it is decided in particular by the control unit, whether one leaf or a plurality of leaves are unlocked. The door leaves can belong e.g. to a double-leaf door or doors arranged one behind the other. For example, for a wheelchair user or a nurse with a hospital bed, both door leaves of a double-leaf door will be unlocked, while only the active leaf of the double-leaf door will be unlocked for individual people. The determination of whether one or a plurality of door leaves are unlocked can be stored in a database of the control unit or can be received by the control unit as part of the access attribute. For example, a reading unit sends the access attribute designed in this way to the control unit.

According to an advantageous further development of the disclosure, it can be provided that the door system comprises at least one, preferably a plurality of, particularly preferably all, of the following further door components, which are connected to the first communication bus:
an escape route controller, in particular an escape route security system,
a door lock, in particular an escape route security system,
an authentication device, in particular a key switch, in particular an escape route security system,
a motor lock, in particular a panic motor lock,
a hazard sensor, in particular a smoke detector,
a hazard detector control center to which hazard sensors, in particular smoke detectors, are connected in a wireless or wired manner,
a drive controller, in particular a door drive,
a program switch, in particular a door drive, and
at least one sensor, in particular a safety sensor and/or a movement sensor, in particular of the door drive.

The other door components mentioned can preferably be functionally assigned to an escape route security system or a motorized door drive. The escape route security system can have an escape route controller, which is connected to the door lock and/or the authentication device via the first communication bus and implements an escape route controller. The escape route controller and the door lock are collectively referred to as escape route components.

The motorized door drive can have a drive controller, which is connected to the program switch and/or at least one sensor via the first communication bus and carries out drive control.

Alternatively, the other door components can be at least partially functionally assigned to the control unit and, for example, can be actuated centrally via the control unit. A functional separation between, for example, escape route security system and motorized door drive can thus be at least partially overcome. The door system can also comprise a manual button, in particular of a door drive, and/or a key switch, in particular of an escape route security system.

The door lock causes the door to be locked and, in particular, to be automatically released as an escape door if the electrical power supply is interrupted. The door lock can be designed as an electromagnetic or as an electromechanical door lock.

The at least one sensor preferably detects people approaching one side or both sides of the door and/or a blocking of a route of the door. The program switch is used to set an operating mode of the motorized door drive. The hazard sensor can be an individual sensor or can comprise a plurality of individual sensors. A plurality of individual sensors can first be connected to the hazard detector control center, with the hazard detector control center transmitting the hazard signal.

According to an advantageous further development of the disclosure, it can be provided that the communication within the first communication bus and/or the second communication bus is encrypted, with a plurality of door components of the door system in particular communicating with one another in encrypted form. Encrypted communication makes the door system secure against faults and tampering that can occur on the corresponding communication bus. Other participants that are physically connected to the communication bus cannot monitor or carry out any communication with the door components. To establish encrypted communication, for example, an authenticity check of the door components can be carried out during commissioning or during configuration. For this purpose, each door component can be assigned a unique identifier, which can be verified, for example, via a manufacturer database of the door components. The door components can thus authenticate themselves to other door components. Alternatively or additionally, when installing or configuring the door system, encrypted communication can be set up on site if, for example, there is access to all door components. All messages on the first or second communication bus are preferably fully encrypted.

According to an advantageous further development of the disclosure, it can be provided that the door system, in particular the control unit, has knowledge of door components installed in the door system and/or a function of the door components and is designed to determine changes of the installed door components and/or the function of the door components, with the door system changing to a defined state, in particular an alarm being generated, if a change is determined. This protects the door system against tampering and ensures correct operation by assuming the defined state if door components or their function change. In the defined state, the change can be verified. In this defined state, the door system is preferably deactivated or restricted in its function. When the defined state is recognized, the configuration of the door system is preferably automatically adapted or is requested to adapt to the changes.

By knowing the door components installed in the door system, the use of non-approved door components can be recognized and prevented in order to ensure reliable operation of the door system with approved door components. A failure of a door component can also be recognized as a change, for example if the door component no longer communicates with the control unit. This improves the reliability of the door system. For example, the control unit can identify and record all door components that send messages via the first communication bus. All door components preferably register with the control unit with their functionality and/or their door component type, so that their function and/or their door component type can be assigned in the control unit to each door component. This simplifies installation and configuration of the door system.

The control unit can initially and/or repeatedly request all door components to register with it. To carry out the configuration, this information can, for example, be accessed locally by the computing unit via the second communication bus or via the transmission unit using a mobile terminal.

The control unit is preferably designed to independently monitor the correctness of the connection logic of the other door components and their reliable function and to thereby display or report detected errors and, if necessary, to indicate a solution for the detected errors. The door system, in particular the control unit, can also have knowledge of a desired function of the door system and/or door components or door component types required for this, for example via a configuration by the computing unit or mobile terminal or via preconfiguration during production.

The control unit can compare the required door components or door component types with door components installed in the door system.

During commissioning, the mobile terminal preferably has knowledge of a desired function of the door system and door components or door component types required for this and compares the required door components or door component types with door components installed in the door system.

If the installed door components deviate from the required door components or door component types, the control unit and/or the mobile terminal can output an error and/or instructions stored electronically in the control unit on how to continue commissioning the door system and/or operating the door system. The preconfigured control unit can also automatically put the door system into operation after it has identified and, if necessary, configured all the necessary door components. This can be done in particular after the control unit has received an assignment of the required door components to the installed door components directly or indirectly from the mobile terminal.

According to an advantageous further development of the disclosure, it can be provided that the operating state of the other door components connected to the first communication bus is available to the control unit, with the control unit being designed to report the operating state of the door system to the computing unit via the second communication bus.

The operating state comprises, in particular, information about the correct functioning of the corresponding door component. The operating state may comprise the state of the door component. For example, the locking device can assume the states “unlocked” or “locked”. A door lock can, for example, output “door locked” or “door unlocked” as the operating state. Accordingly, a motor lock can output a bolt status as the operating state. For example, the escape route controller can assume the state “pre-alarm” or “main alarm”. An escape route controller can, for example, output a status of a timer of the unlocking time as the operating state. For example, a drive controller can assume the operating state “door open” or “door closed”. Alternatively or additionally, the drive controller can output “door opens”, “door is held” or “door closes” as the operating state. In particular for the drive controller, various other operating states are possible, for example a set operating mode.

According to an advantageous further development of the disclosure, it can be provided that the door system comprises an escape route security system, with the escape route security system comprising an escape route controller, a trigger element, in particular an emergency button, and a door lock, with the escape route controller actuating the door lock after the trigger element has been actuated in order to unlock the door lock.

The control unit is preferably not involved in the actuation of the door lock after the trigger element is actuated. The escape route security system is thus formed by other door components as a subsystem of the door system and implements a function for escape route control. This allows the door lock to be actuated quickly to unlock the escape door. Irrespective of this, the escape route security system or the door components belonging to the escape route security system can communicate with the control unit in order, for example, to report operating states and/or alarms and/or to unlock the door lock after authentication.

The escape route security system can communicate with a door drive, for example, in order to implement a coordinated process of control of the escape route security system and door drive. The communication can thereby take place directly between the escape route controller and the drive controller, or indirectly via the control unit. The trigger element can activate the escape route controller when actuated. The door lock locks the door, with the lock being released in the event of an evacuation. The escape route controller and the door lock are preferably door components that are connected to and communicate via the first communication bus. The escape route controller is preferably designed to send and receive CAN Open Safety messages via the first communication bus, in particular to the door lock or from the door lock.

According to an advantageous further development of the disclosure, it can be provided that the door system is designed to receive a change of the configuration or an update of the configuration of the door system, in particular from the mobile terminal.

A configuration of the escape route security system, in particular an assignment of a door lock to a trigger element, the approval of a time delay until unlocking after actuation of the trigger element, the length of the time delay, approval of a deactivation of the trigger element is preferably only permitted on site. For example, the escape route security system can be configured via wireless near-field communication with the mobile terminal.

The change of the configuration or the update of the configuration of the door system is preferably received by the control unit. For this purpose, the mobile terminal can be connected to the escape route controller or preferably to the control unit in terms of data technology on site, so that it is ensured that these safety-related parameters are reliably configured. The configuration can be verified immediately on site.

A parameter of the escape route security system, e.g. the length of a time delay, approval of a deactivation of the trigger element, approval of a time delay is referred to as a safety-related parameter.

For example, a parameter of the escape route security system, e.g. the length of a time delay, approval of a deactivation of the trigger element, approval of a time delay, can be changed during commissioning on site by sending the change from the computing unit or from the mobile terminal and receiving it from the control unit. The in particular safety-related parameter can be changed e.g. by input into the mobile terminal. The control unit sends the changed parameter of the escape route security system to an escape route component, in particular to the escape route controller. If there are a plurality of escape route components, in particular a plurality of escape route security systems, in the door system, the control unit can preferably send the changed parameter selectively to the at least one escape route component, in particular escape route controller, for which the parameter is provided.

It is preferably provided that the escape route component, in particular the escape route controller, which receives the parameter from the control unit, outputs a visual and/or acoustic sign that a parameter has been received.

The installer preferably confirms, e.g. on the mobile terminal and/or on the escape route controller that the correct escape route controller has output the acoustic and/or visual sign. After confirmation, the parameters are preferably stored for use in the escape route controller.

Additionally or alternatively, before the parameter is sent, the control unit causes the escape route controller that is to receive the parameter to output a visual and/or acoustic sign. The installer preferably confirms, e.g. on the mobile terminal and/or on the escape route controller that the correct escape route controller has output the acoustic and/or visual sign. After confirmation, the parameter is preferably sent to the escape route controller.

In this way it can be ensured that the correct escape route component has received the changed safety-related parameter. The installer must therefore be on site to change the parameter of the escape route security system. The change is thus carried out in a particularly reliable manner. In order to carry out the visual and/or acoustic sign, it is preferably provided that the escape route component comprises a display element. The display element is preferably used by the door component during operation of the door system in order to output a visual and/or acoustic sign. For example, the display element can be designed to display an alarm state after actuation of the trigger element.

Additionally or alternatively, it can be provided that the on-site installer performs an action on the escape route component, in particular on the escape route controller or a component fixedly wired to the escape route controller or integral with the escape route controller, in order to confirm and/or determine that the escape route component has received or should receive the changed safety-related parameters. For example, the installer can actuate the trigger element, in particular the emergency button, or a key switch for this purpose.

It can be provided that if a preset safety-related parameter is to be stored by the escape route controller for use, that the escape route component, in particular the escape route controller, which receives the parameter from the control unit, outputs a visual and/or acoustic sign that a parameter has been received or a parameter should be received. It can be provided that the on-site installer performs an action on the escape route component, in particular on the escape route controller or a component fixedly wired to the escape route controller or integral with the escape route controller, in order to confirm and/or determine that the escape route component has received or should receive the changed parameters.

It may be that the installer requires additional authorization so that the installer can perform an action where the end result is a preset or safety-related parameter being stored by an escape route controller for use. For example, additional authentication on the mobile terminal may be necessary.

It is preferably provided that the escape route controller sends the safety-related parameter to the mobile terminal before it is stored for use. The mobile terminal compares the safety-related parameter originally sent with the parameter received back from the escape route controller. A preset or safety-related parameter can only be stored for use by an escape route controller if the parameter sent and the parameter received back match.

If the door system comprises a plurality of escape route components, in particular a plurality of escape route controllers, it can be provided that the control unit receives the changed parameter together with a function of the escape route component, in particular the escape route controller. The function preferably comprises a position of the escape route component, e.g. “on the active leaf” or “on the first door”. The control unit comprises or preferably receives an assignment of the function of the escape route component to a bus address. As a result, the control unit can selectively send the changed parameter to the escape route component.

The configuration can be verified immediately on site with a test run. After the parameter has been changed, it is verified whether the correct escape route component, in particular the correct escape route controller, has correctly received the changed parameter. If e.g. the delay time has been changed, the trigger element, which is logically linked to the escape route controller that has received the changed parameter, is actuated and the delay time until the door lock is unlocked is measured. The result is preferably logged, in particular, electronically.

Other parameters, in particular parameters that are not used to provide the escape route, can be configured, for example, via the second communication bus, as described above. The escape route security system is implemented here by way of example as a subsystem of the door system. The configuration can comprise one or a plurality of the parameters mentioned.

According to an advantageous further development of the disclosure, it can be provided that the door system comprises an escape route security system, with the escape route security system comprising an escape route controller, a trigger element, in particular an emergency button, and a plurality of door locks, with the escape route controller actuating a plurality of door locks, which are assigned to a plurality of doors, for unlocking, based on the actuation of a trigger element. The door system is therefore designed in particular for operation for a plurality of doors with only one escape route security system. In the case of doors that are located close to one another locally, in particular, it can be assumed that all of these doors will be unlocked together in order to release the escape route. As a result, the door system can on the one hand have a simple design and on the other hand reliably provide escape routes. Preferably, the escape route security system comprises a plurality of trigger elements that can be arranged in a distributed manner, for example a trigger element on each door of the door system. In particular, at least one trigger element is assigned to each of the plurality of doors.

In order to re-lock a door, an action preferably must be performed on the trigger element assigned to the door to be locked. In particular, this generates an electrical signal. In order to enable re-locking of the plurality of door locks that were unlocked after a trigger element was actuated, an action must be performed on the trigger element assigned to the door that was unlocked based on the actuation of a trigger element. For example, the trigger element is a mechanically non-latching emergency button. It can be provided that the trigger element, in particular the mechanically non-latching emergency button, must be pressed again so that the respective door can be re-locked.

It can also be provided that authentication, i.e. authorization for the door to be re-locked, must be present. It may be that a door component with a detection unit is assigned to the re-locking door. The detection unit must receive an authorization, e.g. an authorized access attribute so that the door can be re-locked. For example, a key switch assigned to the door to be re-locked can be actuated for this purpose. In another example, a reading unit is assigned to the door to be re-locked. For re-locking, it may be that an authorization, in particular an access attribute, is received at the reading unit.

It may be that a predetermined time sequence and/or order must be observed when acting on the trigger element and during authentication. The control unit preferably comprises an assignment of the function of the door components with the detection unit to a bus address. The function can comprise the position.

According to an advantageous further development of the disclosure, it can be provided that the door system comprises at least one first and one second door lock, with the first door lock being provided to be arranged on a first door and the second door lock being provided to be arranged on a second door, with a condition being stored in the door system, which determines the timed process of the unlocking of the second door lock after the unlocking of the first door lock. Preferably, the first and second door locks are connected to the first communication bus.

The door system is preferably designed to override the condition after a trigger element has been actuated or after authentication, in particular depending on an access attribute. The door locks are assigned to different doors, which are unlocked in normal operation according to the stored condition. Thus, in normal operation, at least one condition must be fulfilled before a door is unlocked or opened. The doors can form a door interlock, for example, with only one of the doors allowed to be unlocked and possibly open during normal operation. A condition therefore preferably corresponds to the fact that the other door is closed. In particular, the first door is first unlocked via the assigned door lock before the second door is then unlocked via the assigned door lock, usually after the first door has been locked again. At least one other or additional condition, such as e.g. the end of a decontamination, may be provided.

However, in the event of an evacuation, in particular in the event of a rescue operation by a rescue service, it can be advantageous for the doors to be unlocked and possibly opened at the same time, so that the rescue service can quickly pass through the interlock. It can therefore be provided that the condition is overridden by actuating a trigger element, in particular an emergency button. The door locks and the trigger element are preferably part of an escape route security system.

Additionally or alternatively, it can be provided that the condition is overridden by the authentication of an access attribute. In particular, the condition is only overridden for at least one access attribute, while the condition must be met for at least one other access attribute. For example, the condition is overridden for an access attribute of a firefighter, while the condition must be met for a resident or worker. Whether or not the condition is to be overridden can be stored in a database of the control unit assigned to the access attribute. Alternatively, the determination as to whether or not the condition is to be overridden is part of the access attribute and is transmitted to the door system, in particular to the detection unit, each time the access attribute is read in. It may be that the determination of whether or not the condition is overridden depends on the manner of use of the access means. For example, a predefined gesture or a predefined length of communication connection must be used for the condition to be overridden.

Whether or not the condition is to be overridden may depend on an access attribute assigned to an individual. A person can have a plurality of access attributes. For example, on the one hand, a person can have an access attribute as a normal user, for which the condition must be met. On the other hand, the person may have an access attribute in the capacity of security or rescue personnel, which overrides the condition.

According to an advantageous further development of the disclosure, it can be provided that the control unit connects further door components, which are to be assigned to different doors, to the computing unit via the second communication bus, with the further door components being connected to the control unit via a first communication bus.

The door system is designed for a plurality of doors. The door system comprises door components that are intended to be arranged on different doors. The connection to the control unit takes place via the first communication bus. That is to say, the door components intended to be arranged on different doors are connected to the first communication bus. The control unit is connected to the second communication bus. However, the other door components of the door system are not connected to the second communication bus. Instead, the remaining door components communicate with the control unit via the first communication bus. The control unit then communicates with the computing unit via the second communication bus. The control unit thus serves as a communication intermediary between the computing unit and the other door components of the door system.

Communication takes place within the door system via the first communication bus in order to operate the door system. The other door components can be connected to the control unit via a plurality of first communication buses. Accordingly, functionally separate first communication buses can be formed which do not affect one another and allow short access times due to a reduced number of participants. The first communication buses can be e.g. a CAN bus and an RS485 or an RS-232 bus. For example, the reading unit or reading units and the control unit are connected to an RS 485 bus.

In particular, in order to be able to design the door system for a plurality of doors, individual door components must be assigned to different doors and/or to one another. For example, a reading unit of the first door must be logically linked to a locking device of the first door. This ensures that when an access attribute is received at the reading unit of the first door, the first door and not another door is unlocked.

When commissioning on site, a bus address of a door component is preferably linked to a function of the door component in the door system. The link is preferably stored in the control unit. In particular, a function is understood to mean a door component type, e.g. a drive controller, a motor lock, a sensor or the like. If a plurality of door components of the same door component type are present in the door system, the function preferably also comprises a position, e.g. drive controller of the active leaf, motor lock of the passive leaf, reader of the first door or sensor on the second door. Since the control unit knows which bus address is linked to which function, processes can be carried out via the first communication bus or the first communication buses, in particular by means of firmware. It can be sufficient here that the functions of the door components are stored in a functional process in the configuration and/or in the firmware, which can be received in particular by the computing unit. During commissioning on site, the assignment to the specific door components takes place.

If a door component type is present only once in the door system, the door component can report its door component type to the control unit, which links the door component type and thus the function with the bus address of the door component. If a door component type is present in the door system multiple times or if e.g. for security reasons, the door component types or the required door components are manually linked to the bus address, the mobile terminal in particular has knowledge of an identifier of the door component, e.g. the bus address. An installer performing the commissioning method may assign a position and/or the door component type and/or the required door component to the identifier. For this purpose, possible positions, possible door component types and/or possible required door components can be displayed on the terminal. In addition, the identifier can be displayed on the mobile terminal. The installer can select the correct position, the correct door component type and/or the correct required door component on the mobile terminal. The assignment made in this way is sent to the control unit.

In order for the installer to be able to select the correct position, the correct door component type and/or the correct required door component on the terminal, it can be provided that the installer can use the mobile terminal to cause the door component of the displayed identifier to output an acoustic and/or visual sign. Alternatively, the installer can identify the identifier on the door component.

The door system can comprise a plurality of door components with detection units, e.g. reading units, for receiving an access attribute. The door system can also comprise a plurality of locking devices. An assignment of the door components with the detection units to the locking devices can be stored electronically in the door system, in particular in the control unit. The assignment can be stored electronically, at least indirectly. By assigning the reading units to the locking devices, a locking device can be selectively actuated for unlocking based on an access attribute received at a reading unit in the event of successful authentication. In other words, after receiving an access attribute by way of the receiving unit and successful authentication, at least one locking device is actuated for unlocking, while another locking device remains locked. This allows in particular the use of the door system e.g. on a plurality of doors. The door system, in particular the control unit, is preferably designed to link bus addresses of the door components with the detection units, in particular the reading units, to a function of the door component in the door system and to link locking devices to a function of the locking devices in the door system during commissioning on site. The function can comprise the position, e.g. “on the first door”. The function can therefore be “locking device for the first door”. Since the bus address is assigned to the function, the control unit can actuate the door component with the desired function via the assigned bus address in a functional process. To assign the function to the bus address, the installer can input e.g. a position on the mobile device during commissioning.

The functions, e.g. “reading unit for the first door” and the function “locking device for the first door”, can be provided in a functional process of the door system. In particular, the functional process is stored electronically, at least in part, in the control unit. The functional process can comprise that the control unit receives the access attribute of the reading unit with a first function, e.g. “reading unit for the first door”, verifies the access authorization and, if authentication is successful, the linked locking device, e.g. with the function “locking device for the first door” actuates for unlocking. Actuation of a locking device that is not linked to the reading unit from which the access attribute was received, e.g. “Locking device for the second door, does not take place. The actuation can be direct or indirect via the escape route controller or the drive controller. The locking device is preferably connected to the first communication bus and the reading units are connected to a further first communication bus.

A door system preferably comprises exactly one control unit. Only the control unit is preferably used for the connection to the computing unit.

The above advantage is also achieved by providing an access system with the features of claim 15. Further features and details of the disclosure result from the respective dependent claims, the description and the drawings.

The advantage is achieved in particular by providing an access system with an above door system and with a computing unit, with an image of the door system being stored in the computing unit, with the door components connected to the first communication bus each comprising an identifier, with the identifiers of the door components being part of the image of the door system being stored in the computing unit and/or with past and current operating states of the door system being stored in the computing unit.

The image can also comprise operating states of the door components. The image can comprise parameters of the door components. The image can comprise the place and/or date of manufacture of the door components. The image can comprise maintenance data of the door components. The image can comprise a circuit diagram of the door components. The identifiers enable the door components to be identified. The identifiers can also be used for communication via the first communication bus in order to assign the door components. Storing the operating states enables efficient maintenance and error analysis of the door system. For example, maintenance intervals for the drive controller or drive motor can be adjusted based on a number of door openings. This prevents unnecessary maintenance and at the same time reduces the risk of the door system failing due to overdue maintenance.

The above advantage is achieved by providing an access system with the features of claim 16. Further features and details of the disclosure result from the respective dependent claims, the description and the drawings.

The advantage is achieved in particular by providing an access system with one or a plurality of the above door systems, with at least one door system comprising an authentication device, with the authentication device being designed to receive an access attribute for authentication, with the door system being designed, based on the access attribute or the type of use of the access attribute,
to automatically lock a door and/or lock a motor lock in one or a plurality of door systems,
to automatically unlock a door lock and/or a motor lock in one or a plurality of door systems,
to decide whether a locking element is actuated for opening a door leaf or locking elements are actuated for opening a plurality of door leaves, or
a timed process for unlocking a locking element of a second door drive after the actuation of a motor of a first door drive is carried out according to a condition stored in the door system or is overridden.

The authentication enables actions to be performed simultaneously for different doors, in particular for a plurality of door systems, as a result of which efficient operation of the access system is made possible. The door systems can, for example, together form an interlock with a plurality of doors, represent different door leaves of a door, be arranged on a common corridor or building section or be logically and/or functionally linked in another way.

Based on the authentication or the access attribute, the state of a plurality of door systems can change at the same time. For example, in the event of a commotion, a principal can lock all the doors of a corridor or school building by the principal identifying themselves with a provided access attribute. In this case, the control units can be connected to one another via the second communication bus. The control units can send messages to each other via the second communication bus.

In addition, the configurations of the above door system can be transferred to the configuration of the mentioned access systems and vice versa.

### BRIEF DESCRIPTION OF THE DRAWINGS

Further advantages, features and details of the disclosure result from the following description, in which exemplary embodiments of the disclosure are described in detail with reference to the drawings. The features mentioned in the claims and in the description can thereby each be essential to the disclosure individually or in any combination. Technical features with the same function are provided here with identical reference symbols in the figures. They show:

FIG. 1 a schematic representation of an access system according to a first, preferred embodiment with a door system that comprises a door drive, an escape route security system and a control unit, which are connected via a first communication bus, and a plurality of computing units connected to the control unit via a second communication bus,

FIG. 2 a schematic representation of an access system according to a second embodiment with two door systems, each comprising a door drive and a control unit, which are connected via a first communication bus, and a plurality of computing units connected to the control units via a second communication bus, and

FIG. 3 a further exemplary embodiment of a door system according to the disclosure and an access system according to the disclosure

### DETAILED DESCRIPTION OF THE DRAWINGS

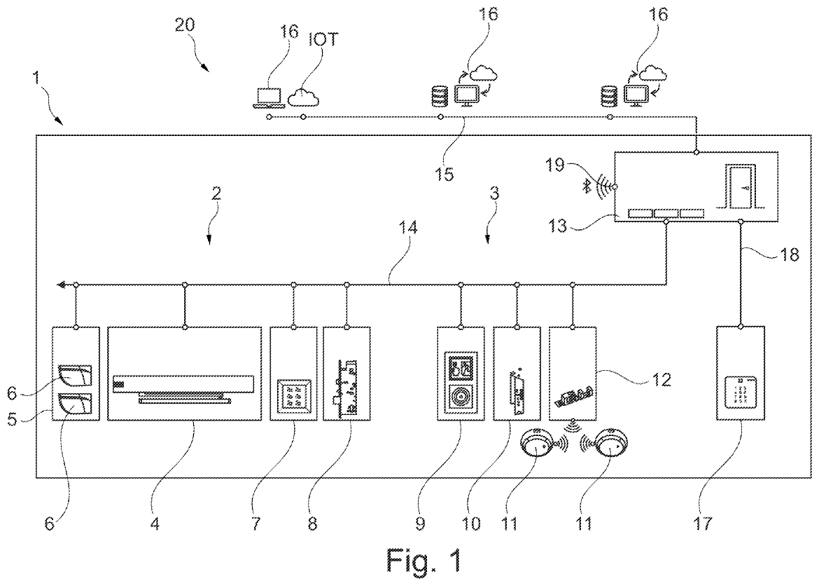

A door system 1 according to the disclosure in accordance with a first preferred embodiment is represented schematically in FIG. 1.

The door system 1 comprises a motorized door drive 2 and an escape route security system 3, as can be seen in FIG. 1.

The motorized door drive 2 comprises a drive controller 4 to actuate a drive motor of the door. The drive motor drives the door to open, close and/or hold. The drive controller 4 is designed here as a 4-quadrant controller. The electronic drive controller 4 preferably comprises a processor and a memory.

In this exemplary embodiment, the motorized door drive 2 also comprises a sensor unit 5 with two sensors 6 in order to detect when people are approaching both sides of the door. The sensors 6 are designed as movement sensors, with one sensor 6 being fitted on each side of the door in order to detect the approach of a person to a corresponding side of the door. Additionally, safety sensors not represented can be provided, which detect a person in a travel path of the door.

The motorized door drive 2 also comprises a program switch 7 for setting an operating mode of the motorized door drive 2.

The motorized door drive 2 also comprises a motor lock 8 to actuate a bolt and/or a latch of the door.

The escape route security system 3 comprises an escape route controller 9 and an electrically actuatable door lock 10. The motor lock 8 and the electrically actuatable door lock 10 form locking elements 8, 10 for the respective door or a respective door leaf of the door.

The escape route security system 3 also comprises a trigger element, not represented individually, which is designed here as an emergency button integral with the escape route controller 9, i.e. the emergency button is attached to a housing of the escape route controller 9.

The electronic escape route controller 9 preferably comprises a processor and a memory. The escape route controller 9 is designed to actuate the door lock 10. The door lock 10 keeps the assigned door closed and unlocks it after activation. In the event of a power failure due to an interruption in an electrical power supply, the door lock 10 automatically releases the respective door as an escape door.

The door system 1 comprises a plurality of smoke detectors 11 as hazard sensors, which are connected to a hazard detector control center 12. In this exemplary embodiment, the smoke detectors 11 are assigned to the hazard detector control center 12 of the escape route security system 3. The smoke detectors 11 are connected to the hazard detector control center 12 via a radio link, for example using Bluetooth Low Energy.

The door system 1 of the first embodiment also comprises a control unit 13. The control unit 13 is a data processing device and comprises a processor and a memory in which a program for execution in control unit 13 is stored.

In this exemplary embodiment, the control unit 13 also comprises a transmission unit 19, which is designed as a transmitting and/or receiving unit for wireless near-field communication, in particular Bluetooth Low Energy. The control unit 13 is designed to use the transmission unit 19 to communicate with a terminal, in particular a mobile terminal, for commissioning, for configuring and/or for access authorization communication of the door system 1.

The motorized door drive 2, the escape route security system 3 and the control unit 13 are connected to one another via a first communication bus 14. Accordingly, both the drive controller 4, the escape route controller 9 and the control unit 13 are connected to the first communication bus 14. In addition, the sensor unit 5, the program switch 7, the motor lock 8, the electrically actuated door lock 10 and the hazard detector control center 12 are connected directly to the first communication bus 14. Instead of the sensor unit 5 as a unit, the sensors 6 can alternatively also be connected individually to the first communication bus 14.

In detail, the sensor unit 5, the program switch 7 and the motor lock 8 are in communication with the drive controller 4 via the first communication bus 14 in order to send signals to the drive controller 4 and to receive control signals from the drive controller 4. Correspondingly, the door lock 10 and the hazard detector control center 12 are in communication with the escape route controller 9 via the first communication bus 14. The motorized door drive 2 and the escape route security system 3 each form corresponding functional units.

The first communication bus 14 is designed here as a wired bus according to the CAN standard. All participants, i.e. the drive controller 4, the escape route controller 9, the control unit 13, the sensor unit 5, the program switch 7, the motor lock 8, the electrically actuated door lock 10 and the hazard detector control center 12, are each assigned a unique prioritization/identification, with the participant, which has the highest prioritization, being able to use the first communication bus 14 in the case of simultaneous sending.

Different types of messages can be exchanged between the participants via the first communication bus 14, for example in order to configure the respectively other controller or to synchronize different activities with one another. The messages can thereby contain information relating to the controller that is sending the message, or instructions to the controller that is receiving the message. For example, the escape route controller 9 can inform the drive controller 4 about the triggering of the escape route controller 9, for example via the emergency button. Alternatively, the escape route controller 9 can request the drive controller 4 to open or close the door. The same applies in reverse, starting from the drive controller 4.

The door system 1 has a functional memory for functional processes which are at least indirectly coordinated in the process by the escape route controller 9 and the drive controller 4. The functional processes are stored as firmware in the door system 1 and define a coordinated process for controlling the door drive 2 and the escape route security system 3 with the door lock 10. The functional memory is arranged in the drive controller 4, the escape route controller 9 and the control unit 13 in order to implement control functions therein and to carry out a coordinated process for controlling the door drive 2 and the escape route security system 3 with the door lock 10. For this purpose, there is communication between the door drive 2 and the escape route security system 3 with a corresponding exchange of messages.

Furthermore, the control unit 13 is connected to a second communication bus 15, which is designed as an Internet connection using the IP protocol. A plurality of servers 16 are connected to the control unit 13 via the second communication bus 15. The servers 16 can be designed as cloud servers, for example. The connection of the control unit 13 to the servers 16 is preferably secured and encrypted. The second communication bus 15 is connected to the Internet via a secure communication unit not represented here, for example a firewall.

The control unit 13 has knowledge of other door components 4, 5, 6, 7, 8, 9, 10, 12 installed in door system 1 and/or a function or a door component type of the other door components 4, 5, 6, 7, 8, 9, 10, 12 and is designed to determine changes of the installed other door components 4, 5, 6, 7, 8, 9, 10, 12 and/or the function or the door component type of the other door components 4, 5, 6, 7, 8, 9, 10, 12. If a change is determined, the door system 1 goes into a defined state and generates an alarm. In the defined state, the door system 1 is deactivated, for example, or restricted in its function. The control unit 13 identifies all other door components 4, 5, 6, 7, 8, 9, 10, 12 by all the other door components 4, 5, 6, 7, 8, 9, 10, 12 reporting to the control unit 13 with their functionality or their door component type.

The door system 1 forms an access system 20 together with the computing units 16. The access system 20 is designed for encrypted communication via the first communication bus 14, so that all door components 4, 5, 6, 7, 8, 9, 10, 12, 13 communicate via the first communication bus 14 in encrypted form. Encrypted communication also takes place via the second communication bus 15 between the control unit 13 and the computing units 16.

The door system 1 comprises a reading unit 17 for detecting an access attribute, also referred to below as a credential. The reading unit 17 is designed as a reading unit 17 for the electronic access attribute, which is stored, for example, on an authorization card or in an authorization chip with a memory element, and/or as a reading unit 17 for recording biometric data of an access person, in particular as a reading unit 17 for a fingerprint or for iris recognition. The reading unit 17 is connected directly to the control unit 13 via a connection interface 18, which is designed here as an interface according to the RS485 standard.

The door system 1 also comprises an authentication device for checking access attributes, for example for access to a region behind the door or for setting an operating mode of the motorized door drive 2. The authentication device is formed here by the control unit 13. The authentication device compares credentials or biometric data read with the reading unit 17 with stored credentials or biometric data and thus determines whether authorization is present. Based on a way of reading the access attribute, for example reading the access attribute once with the reading unit 17 as opposed to reading the access attribute twice, the door system 1 can act differently.

The other door components 4, 5, 6, 7, 8, 9, 10, 12 also report their operating state to the control unit 13, so that it is available to the control unit 13. The control unit 13 is designed to report the operating state of door system 1 with door components 4, 5, 6, 7, 8, 9, 10, 12, 13 to computing unit 16 via second communication bus 15. The operating state comprises information about the correct functioning of the corresponding door components 4, 5, 6, 7, 8, 9, 10, 12, 13.

The door system 1 has two operating modes, namely automatic mode and manual mode. In automatic mode, when a person approaches one side of the door and/or both sides of the door, which is detected by sensors using the sensor unit 5, the door is opened by the door drive 2 by motor. In manual mode, the door is not opened by the door drive 2 in such manner.

In the door system 1, the control unit 13 takes over central control tasks and carries out a higher-level control of the door system 1. In addition, the drive controller 4 actuates an electric drive motor for opening, closing and/or holding a door. Also in addition, the escape route controller 9 actuates the door lock 10 to lock or unlock the door. There is separate communication between the relevant door components 4, 5, 6, 7, 8, 9, 10, 12, 13 for carrying out the control tasks by the drive controller 4 and/or the escape route controller 9.

The escape route controller 9 is designed to actuate the door lock 10 after the trigger element is actuated in order to unlock the door lock 10. The control unit 13 is thereby not involved in the actuation of the door lock 10 after the trigger element is actuated. The escape route security system 3 thus forms a subsystem of the door system 1 and implements a function for escape route control. The communication between the escape route controller 9 and the door lock 10 takes place as described above via the first communication bus 14, with the escape route controller 9 and the door lock 10 being designed to send or receive CAN Open Safety messages via the first communication bus 14.

The control unit 13 communicates with the computing units 16 via the second communication bus 15. The control unit 13 receives an electronic configuration of door system 1 via second communication bus 15. The electronic configuration is an initial configuration for commissioning the door system 1 or an update of the initial configuration and comprises the following electronic data:
door component types 4, 5, 6, 7, 8, 9, 10, 12, 13 of the door system 1,
transmitter and/or receiver of messages via the first communication bus 14 in the door system 1,
parameters for operating the door system 1,
a test process for the door system 1, in which at least one function or a functional process of the door system 1 is tested for commissioning, and/or
at least one access attribute, based on which the control unit 13 makes an access decision.

The electronic configuration of the door system 1 is thus carried out via the second communication bus 15 as a remote configuration, with a user interface of the control unit 13 for example being provided via the computing unit 16 by means of software, for example as a graphical user interface (GUI). The data of the electronic configuration is transmitted with messages between the control unit 13 and the computing unit 16. Data or a current configuration of control unit 13, if available, is transmitted from control unit 13 to computing unit 16. A (changed) configuration is then transmitted from the computing unit 16 to the control unit 13. Additionally, the control unit 13 can send individual parameters via the first communication bus 14 to the other door components 4, 5, 6, 7, 8, 9, 10, 12 for use in the corresponding other door components 4, 5, 6, 7, 8, 9, 10, 12.

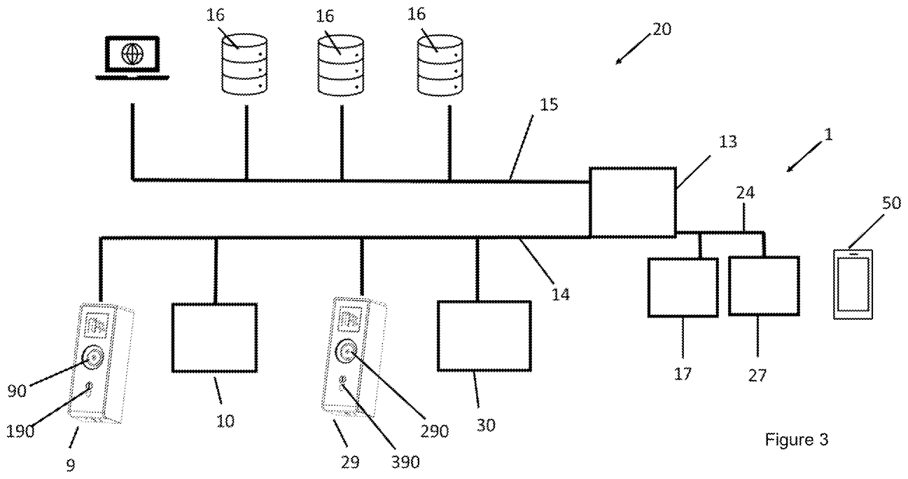

The access system 20 can comprise the mobile terminal 50 represented in FIG. 3. In a particularly secure variant, the initial configuration is changed or supplemented exclusively by the mobile terminal 50 (see FIG. 3). In this case, the supplemented configuration can be sent from the mobile terminal 50 to the control unit 13 via the computing unit 16 and the second communication bus 15. Alternatively, the mobile terminal 50 can send the supplemented configuration directly to the control unit 13.

The door system 1 is designed to receive an update of its configuration from the computing unit 16, for example. In this exemplary embodiment, the update of the configuration does not comprise any configuration of the escape route security system 3, in particular an assignment of a door lock 10 to a trigger element, the approval of a time delay until unlocking after the trigger element is actuated, the length of the time delay, approval of a deactivation of the trigger element. The configuration of the escape route security system 3 is only permitted on site. The configuration of the escape route security system 3 is carried out in particular via a wireless near-field communication with the mobile terminal or a mobile memory. The configuration of the door system 1 can therefore also be updated on site via the transmission unit 19 by the terminal, which is previously connected to the control unit 13. In a particularly secure variant of the method, the configuration can only be updated on site with the participation of the mobile terminal 50, in particular from the mobile terminal or a mobile memory.

In the door system 1, it can also be set that the unlocking time and/or a monitoring time before the door system 1 outputs an alarm when the door is open, is stored in the control unit 13 and/or can be received by the control unit 13 individually for different authorized users or for different authorized user groups or for different access attributes/or access attribute groups.

In addition, the control unit 13 of the first embodiment is designed to make an access decision. The unlocking time, in which the locking device 8, 10 is to unlock in the event of a positive access decision, is stored in the control unit 13 and/or can be received by the control unit 13. The access decision is preferably made based on an access attribute received from the reading unit 17 as part of an authentication. The locking device 8, 10 can be implemented, for example, by the electrically actuated door lock 10 or the motor lock 8. The unlocking time is a time in which the locking device 10 unlocks the door. The unlocking time is a time during which the locking device 8 unlocks the door and/or prevents mechanical re-locking.

It can be provided that the unlocking time and/or the monitoring time is set for the same user depending on a type of verification of the access attribute. For example, a user can be assigned different access means, such as a mobile terminal with a stored access attribute, an authorization card, or an authorization chip, with different unlocking times and/or monitoring times being assigned to the access means.

In a modified embodiment, which is explained in more detail in FIG. 3, the door system 1 comprises an escape route security system 3 with an escape route controller 9, a trigger element, in particular an emergency button, and a plurality of door locks 10. In the modified embodiment, a plurality of door locks 10, which are assigned to a plurality of doors, are actuated together for unlocking based on the actuation of a trigger element by the escape route controller 9. The door system 1 is therefore designed to operate for a plurality of doors with only one escape route security system 3 and one escape route controller 9. Preferably, the escape route security system 3 comprises a plurality of trigger elements that can be arranged in a distributed manner, for example a trigger element on each door of the door system 1.

In an embodiment of the door system 1, not represented, with at least one first and one second locking device 8, 10, with the first locking device 8, 10 being provided to be arranged on a first door, and the second locking device 8, 10 being provided to be arranged on a second door, a condition is stored in the door system 1, which determines the timed process of the unlocking of the second locking device 8, 10 after the first locking device 8, 10 is unlocked. The door system 1 designed in this way is also designed to override the condition after a trigger element has been actuated or after authentication, in particular depending on an access attribute. In normal operation, the two doors are unlocked according to the stored condition, for example to form a door interlock. In the event of an evacuation, the condition is overridden so that the doors can be quickly passed by an emergency service during a rescue operation.

In the configuration of the door system 1 with door components 4, 5, 6, 7, 8, 9, 10, 12, 13, which are to be assigned to different doors, such as the first and second locking device 8, 10 mentioned above, the control unit 13 can connect the other door components 4, 5, 6, 7, 8, 9, 10, 12 to the computing unit 16 via the second communication bus 15.

An image of the door system 1 is stored in one of the computing units 16. The door components 4, 5, 6, 7, 8, 9, 10, 12, 13 connected to the first communication bus 14 each comprise an identifier that is stored in the computing unit 16 as part of the image of the door system 1. Optionally, past and current operating states of the door system 1 are also stored in the computing unit 16.

The image of the door system 1 is filled with data of the installed door components 4, 5, 6, 7, 8, 9, 10, 12, 13 during or after the installation of the door system 1. The image can be transmitted from the computing unit 16 to the control unit 13 for configuration.

Each door system 1 preferably comprises exactly one control unit 13 which establishes a data connection to the server 16.

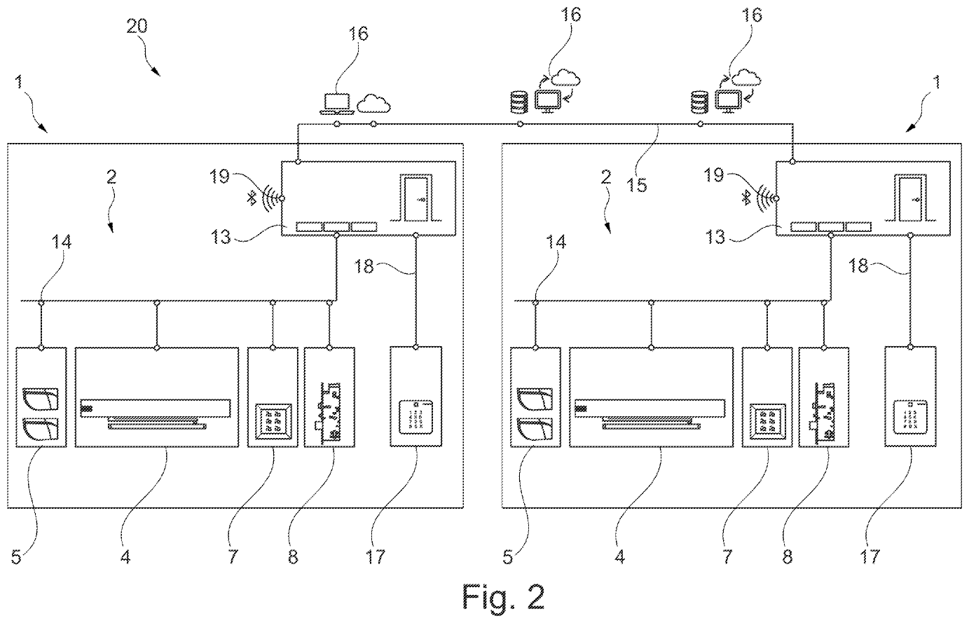

FIG. 2 shows an access system 20 according to a second embodiment. The access system 20 of the second embodiment comprises two door systems 1. In this embodiment, the two door systems 1 of the second embodiment together form an interlock with a plurality of doors which are correspondingly logically and functionally linked to one another. Thus, an interlock can be formed by door components of a door system or by components of a plurality of door systems.

The door systems 1 of the access system 20 of the second embodiment are represented in FIG. 2 compared to the door system 1 of the first embodiment without escape route security systems 3. In an alternative embodiment, the door systems 1 of the access system 20 of the second embodiment are designed to be identical to the door systems 1 of the first embodiment.

As outlined above in relation to the door systems 1 of the first embodiment, each of the door systems 1 comprises an authentication device, which is formed by the reading unit 17 together with the control unit 13. The authentication device is designed to receive an access attribute for authentication from the reading unit 17 and, based on the access attribute or the type of use of the access attribute,
to automatically lock a door 10 and/or lock a motor lock 8 in one or a plurality of door systems 1,
to automatically unlock a door lock 10 and/or a motor lock 8 in one or a plurality of door systems 1,
to decide whether a locking element 8, 10 is actuated for opening a door leaf or locking elements 8, 10 are actuated for opening a plurality of door leaves, or
a timed process for unlocking a locking element 8, 10 of a second door drive after the actuation of a motor of a first door drive 2 is carried out according to a condition stored in the door system 1 or is overridden.

In the present case, it is irrelevant which of the door systems 1 carries out the authentication. All door systems 1 of the access system 20 are actuated accordingly via the computing unit 16.

In addition, the access system 20 of the second embodiment corresponds to the access system 20 of the first embodiment.

A further exemplary embodiment of a door system 1 according to the disclosure is represented in FIG. 3. The door system 1 of FIG. 3 is provided to be arranged on a plurality of doors. Therefore, the door system 1 comprises a first escape route security system 9, which is intended to be arranged on a first door, and a second escape route security system 29, which is intended to be arranged on a second door. Furthermore, the door system 1 comprises a first door lock 10, which is intended to be arranged on the first door, and a second door lock 30, which is intended to be arranged on a second door. The escape route security systems 9, 29 and the door locks 10, 30 are connected to the first communication bus 14, a CAN bus. Optionally and not represented, motor locks and/or door drives can also be provided to be arranged on the first door and/or on the second door and can be connected to the first communication bus.

The door system 1 comprises a first reading unit 17 provided to be arranged on the first door and a second reading unit 27 provided to be arranged on the second door. The reading units 17, 27 are connected to the control unit 30 by a further first communication bus 24, an RS485 bus. The reading units 17, 27 comprise transmitting and receiving units as detection units with which an access attribute is receivable via wireless near-field communication, e.g. Bluetooth Low Energy, NFC or RFID.

An assignment of the reading units 17, 27 to the escape route controllers 9, 29 and/or to the door locks 10, 30 is stored electronically in the control unit 30. The assignment takes place indirectly in that the door components 9, 10, 17, 27, 29, 30 are each assigned to a position in the door system. In the exemplary embodiment of FIG. 3, the positions correspond to the information “on the first door” and “on the second door”. The control unit 30 also knows the door component type of the door components 9, 10, 17, 27, 29, 30, in this case “escape door controller”, “door lock” and “reading unit”. Since the control unit 30 knows the door component types and the positions of the door components 9, 10, 17, 27, 29, 30, the control unit 30 knows the function of the respective door components, namely “escape door controller on the first door”, “escape door controller on the second door”, “door lock on the first door” etc. The control unit 13 has assigned a bus address of one of the first communication buses 14, 24 to each of the functions.

As a result, the control unit 30 can selectively control the door system 1 in functional processes on the basis of the functions. For example, an access attribute is received at the reading unit 17. The control unit 30 evaluates the access attribute. If the authentication is successful, the control unit 30 only actuates the door lock 10 of the first door for unlocking, and the door lock 30 of the second door is not actuated. Alternatively, the control unit 30 actuates only the first escape route controller 9 so that the escape route controller 9 then unlocks the door lock 10. The escape route controller 29 is not actuated.

An assignment to one another is preferably stored electronically in the escape route controllers 9, 29 and/or in the door locks 10, 30. This ensures that when an emergency button 190, 290 is actuated, only the assigned door lock 10, 30 is unlocked. Unlocking takes place without involving the control unit 30.

During commissioning, each door component 9, 10, 29, 30 connected to the first communication bus 14 receives its own bus address from the control unit 13. Each door component 9, 10, 29, 30 of the door system 1 connected to the first communication bus 13 sends the control unit 13 the door component type of the respective door component 9, 10, 29, 30. If each door component type is present only once in the door system 1, as in the exemplary embodiment in FIG. 1, the control unit 13 or the mobile terminal 50 assigns the bus address to each door component type and therefore to each door component. If the assignment is made by the terminal 50, the assignment is then transmitted to the control unit 13. Thus, the control unit 13 knows the bus address when the control unit 13 has to send a message or command to a specific door component.

In the exemplary embodiment of FIG. 3, there are a plurality of door components of the same door component type. The door components 9, 10, 29, 30, which are present multiple times and are connected to the first communication bus 14, are assigned to a position. For this purpose, identifiers of the door components 9, 10, 29, 30, e.g. the bus address, or a marking assigned to the identifier, e.g. “door lock 1” or “door lock 2” are displayed to an installer during a commissioning method on the mobile terminal 50 after this information has been sent from the control unit 13 to the mobile terminal 50. Additionally, the possible positions of the door components “on the first door” and “on the second door” are displayed to the installer on the mobile terminal 50.

The installer can now select an identifier or a marking, e.g. the identifier of the escape route controller 9. The control unit 13 then receives the command from the mobile terminal 50 that the selected escape route controller 9 has to output a visual and/or acoustic sign. The control unit 13 informs the escape route controller 9 about the command. The escape route controller then outputs a visual and/or acoustic sign. For this purpose, the escape route controller 9 can use e.g. LEDs arranged around the emergency button 90, which the escape route controller 9 also uses during operation, for example to indicate the actuation of the emergency button 90.

The installer now sees the position at which the selected door component 9, 10, 29, 30, in this example the selected escape route controller 9, is arranged, in this case on the first door. On the mobile terminal 50, the installer can input the correct position, in this case “on the first door”. The mobile end device 50 transmits the correct position “on the first door” and the identifier of the selected escape route controller 9 to the control unit 13.

The mobile terminal 50 or control unit 13 assigns the bus address to each door component whose position has thus become known to the control unit 13. If the assignment is made by the terminal 50, the assignment is then transmitted to the control unit 13. Thus, the control unit 13 knows the bus address when the control unit 13 has to send a message or a command to a specific door component, e.g. to the escape route controller 9 of the first door, but not to the escape route controller of the second door.

The reading units 17, 27 can also be assigned by the installer in an analogous manner to an identifier or a marking by outputting a visual or acoustic sign.

The assignment is not sufficient for the safety-related door components of the escape route security systems 9, 10, 29, 30, namely the escape route controllers 9, 29 and the door locks 10, 30. The door components of the escape route security systems 9, 10, 29, 30 are assigned to one another directly. The door components of the escape route security systems 9, 10, 29, 30 must be selected on the mobile terminal 50 and the assignment must be visible through visual and/or acoustic signs. In addition, the assignment must be verified by the installer and/or by means of a test.

It may be that, during commissioning, an in particular safety-related parameter of the escape route security system is to be transferred or changed. For example, the parameters that preset are that the door locks 10 or 30 are only unlocked after a time delay after the emergency button 90 or 290 is actuated. The preset parameter for the time delay is made available to the control unit 13 by the electronic configuration of the server 16 either via the second communication bus 15 or via the mobile terminal 50. The control unit 13 sends the parameter to the escape route controllers 9, 29.

If the time delay at the first door is to be changed, e.g. omitted, the parameter for the first escape route controller 9 is changed e.g. on the mobile terminal 50 and transmitted to the control unit 13.

The control unit 13 sends the changed or preset parameter, in particular selectively, to the first escape route controller 9. The escape route controller 9 confirms receipt of the changed parameter with a visual and/or acoustic sign. It can be provided that the installer requests the visual and/or acoustic sign on the mobile terminal 50 beforehand. The installer must confirm by actuating the emergency button 90 that the escape route controller 9 has output the visual and/or acoustic sign so that the escape route controller 9 uses the parameter. This means that the safety-related escape route parameters can only be changed on site.

Alternatively, the control unit 13 commands the escape route controller 9 to output a visual and/or acoustic sign before the changed parameter is sent. The installer confirms by actuating the emergency button 90, the key switch 190 and/or on the mobile terminal 50 that the correct escape route controller 9 has been selected. The control unit 13 then sends the changed parameter to the escape route controller 9.

Furthermore, the release of the escape route must then be verified by means of the escape route controller 9, in which the changed parameter is stored electronically. For this purpose, the installer actuates the emergency button 90 and verifies whether the door lock 10 is unlocked immediately without a time delay. It may be that the installer may be prompted on the mobile terminal 50 for verification. It may be that the installer is required to log the verification. The logging preferably takes place electronically on the mobile terminal 50.

In a different variant of the door system 1 of FIG. 3, the actuation of the emergency button 90 of the first escape route controller 9 causes both the first door lock 10 and the second door lock 30 to be unlocked. Thus, the first and the second door lock 10, 30 are assigned to the first escape route controller 9. In order to re-lock the doors by means of the door locks 10, 30 after the emergency button 90 has been actuated, it may be necessary to individually cancel the alarm state on the respective door. This is in particular necessary if the doors were opened after the emergency button 90 had been actuated.

In order to re-lock the first door lock 10 on the first door, it is necessary to actuate the key switch 190 and to actuate the emergency button 90 arranged on the first door. The two actuations must occur in a predefined time and/or order. Alternatively, an authorization, in particular an access attribute, can be received by the reading unit 17 and the emergency button 90 arranged on the first door can be actuated. The receipt of the authorization and the actuation of the emergency button 90 must take place in a predefined time and/or order.

In order to re-lock the second door lock 10 on the second door after the emergency button 90 of the first door has been actuated, it is necessary to actuate the key switch 390 and to actuate the emergency button 290 arranged on the second door. The two actuations must occur in a predefined time and/or order. Alternatively, an authorization, in particular an access attribute, can be received by the reading unit 27 and the emergency button 290 arranged on the second door can be actuated. The receipt of the authorization and the actuation of the emergency button 290 must take place in a predefined time and/or order.

The above explanation of the embodiments describes the present disclosure exclusively in the context of examples. It goes without saying that individual features of the embodiments can be freely combined with one another, insofar as this makes technical sense, without departing from the scope of the present disclosure.

1. A door system for one or a plurality of doors,
wherein the door system comprises a plurality of door components,
wherein one of the door components is designed as a control unit, and
wherein the control unit is connected to a plurality of further door components, wherein the further door components are connected to the control unit via a plurality of first communication buses.

2. The door system according to claim 1,
wherein the control unit is configured to be connected to a second communication bus, wherein the control unit is designed to communicate with a computing unit in a cloud via the second communication bus, wherein the control unit receives an electronic configuration of the door system via the second communication bus.

3. The door system according to claim 1, wherein
the control unit comprises a transmission unit, in particular a transmitting and/or receiving unit for wireless near-field communication, in particular Bluetooth Low Energy, wherein the transmission unit is used to communicate with a terminal, in particular a mobile terminal, for commissioning, for configuring and/or for access authorization communication.

4. The door system according to claim 1,
wherein the control unit is designed to make an access decision.

5. The door system according to claim 19, wherein the reading unit or reading units and the control unit are connected to an RS 485 bus.

6. The door system according to claim 1,
wherein the door system comprises the following door components, which is connected to the first communication bus.

7. (canceled)

8. (canceled)

9. The door system according to claim 1, wherein the door system comprises a plurality of door components with detection units for receiving an access attribute and a plurality of locking devices, wherein an assignment of the door components with the detection units to the locking devices is stored electronically in the control unit, is designed to receive bus addresses of the door components with the detection units linked to a function of the door components in the door system during commissioning on site, wherein the link can be received by the mobile terminal.

10. The door system according to claim 1,
wherein the door system is designed to receive a change of the configuration or an update of the configuration of the door system, wherein a configuration of an escape route security system is only permitted on site, in particular takes place via wireless near-field communication with the mobile terminal.

11. (canceled)

12. (canceled)

13. (canceled)

14. An access system with a door system according to claim 1 and with a computing unit, wherein an image of the door system is stored in the computing unit,
wherein past and current operating states of the door system are stored in the computing unit.

15. The access system with one or a plurality of door systems according to claim 1, wherein the control unit is designed to receive an access attribute for authentication, wherein the door system is designed, based on the access attribute or the type of use of the access attribute,
to decide whether a locking element is actuated for opening a door leaf or locking elements are actuated for opening a plurality of door leaves.

16. The door system according to claim 2, wherein during commissioning on site a bus address of the door components has been linked to a function of the respective door component in the door system, and in that the control unit has knowledge of which bus address is linked to which function, processes are carried out via the first communication buses, wherein it is sufficient that the functions of the door components are stored in a functional process in the configuration.

17. The door system according to claim 2, wherein
the electronic configuration comprises the following electronic data:
door component types of the door system.

18. The door system according to claim 16, wherein the door system is configured such that during commissioning on site, if a door component type is only present once in the door system, the door component reports its door component type to the control unit, wherein the control unit links the door component type and thus the function to the bus address of the door component.

19. The door system according to claim 4, wherein the door system comprises at least one reading unit, wherein the control unit is designed to evaluate a credential received from the reading unit by a received access code being compared with an access code stored in the control unit and/or a time window of the credential being compared with the current time.

20. The door system according to claim 1, wherein the first communication buses are a CAN bus and/an RS485 or an RS-232 bus.

21. The access system according to claim 14, wherein the door components connected to a first communication bus each comprise an identifier, wherein the identifiers of the door components are stored as part of the image of the door system in the computing unit in the cloud.

22. The access system according to claim 14, wherein the access system is designed such that the image of the door system is filled with data of the installed door components during or after the installation of the door system.

23. The access system according to claim 14, wherein the access system comprises a mobile terminal, wherein the mobile terminal is designed to have knowledge of an identifier of a door component during commissioning on site, and is designed to
